(19) United States
(12) Patent Application Publication
(10) Pub. No.: US 2026/0128912 A1
(43) Pub. Date: May 7, 2026

(54) GLOBAL BEHAVIORAL-ECONOMICS IDENTITY (BEI) GATEWAY USING HONEYCOMB MULTI-SYSTEM DOMAIN BASEPOINTS, BROWSER-NATIVE ENFORCEMENT, VERIFIABLE RECEIPT OBJECTS (VROs), AND BEIFR2 BOUNDED ROLLBACK

(71) Applicant: FURONG BEI, SAN GABRIEL, CA (US)

(72) Inventor: FURONG BEI, SAN GABRIEL, CA (US)

(21) Appl. No.: 19/437,192

(22) Filed: Dec. 30, 2025

Related U.S. Application Data
(63) Continuation-in-part of application No. 19/056,745, filed on Feb. 19, 2025.

(51) Int. Cl. H04L 9/32

(52) U.S. Cl. CPC H04L 9/3297

(57) ABSTRACT

A computer-implemented identity gateway provides domain-bound consent enforcement and verifiable receipt objects (VROs) for regulated digital interactions over a multi-system basepoint network. A client-side browser-resident identity agent resolves a target domain scope into a versioned compliance profile and routing constraints, executes a consent state machine, and binds an authorization output to the domain scope, a discrete time bucket, and a nonce. The system generates a VRO per event, enabling audit trails, downstream verification, and deterministic reconciliation, including local-first operation for intermittently connected environments. When an anomaly condition is detected, a bounded rollback or callback remediation is applied under boundary rules. Example namespace identifiers (not limiting) include BEI, BEIDID, BEIEID, DRIDX, beistandard, beiterm, and BEIFR2.

### CROSS-REFERENCE TO RELATED APPLICATIONS

This application is a continuation-in-part of U.S. patent application Ser. No. 19/196,039, filed May 1, 2025, entitled “Dynamic BEI Signature BEISign System for Global Users Covering Multi-Sector Demands,” the disclosure of which is incorporated herein by reference in its entirety to the extent not inconsistent herewith. Any claim of domestic benefit is made only as set forth in the Application Data Sheet (ADS) filed herewith.

This application is also related to the Applicant's broader BEI ecosystem work involving decentralized identity resolution, domain-scope routing, verifiable evidence generation, and bounded remediation across multiple sectors. Related materials, if referenced, are provided solely as technical context and not as a claim of priority unless expressly identified as a domestic benefit or priority claim in the ADS.

### TECHNICAL FIELD

This disclosure relates to computer and network security, browser-native authentication and authorization, decentralized identity, domain-scoped routing and policy enforcement, machine-readable compliance profiles, verifiable evidence generation using receipt objects, local-first operation for intermittently connected environments, and bounded rollback mechanisms for preventing and remediating identity theft, fraudulent authorization, and cross-domain misuse. The disclosure further relates to an industry-spanning access routing layer enabling interoperable entry into multiple sector services such as banking, customs clearance, healthcare, education, travel, communications, and Internet of Things (IoT) control.

### BACKGROUND

Digital identity and access control remain fragmented across websites, applications, devices, and jurisdictions. Users may present different credentials (e.g., passport identifiers, driver's license identifiers, medical identifiers, education identifiers, and payment identifiers) across different relying parties, each with distinct authentication flows, policy rules, and revocation behaviors.

Such fragmentation creates technical vulnerabilities and operational failures. Phishing and domain impersonation remain common because conventional login and consent prompts are often not cryptographically bound to an intended domain scope, enabling credential theft and replay across domains. Authorization events are frequently non-auditable because many systems lack standardized, machine-verifiable receipts suitable for forensic analysis and compliance audits. Further, users must repeatedly re-enroll and re-prove identity across sectors and countries, resulting in high operational cost, poor interoperability, and inconsistent security posture.

Remediation is often insufficient: when fraudulent authorization is detected, existing systems frequently lack a standardized bounded remediation path that limits cascading losses and unintended downstream effects. These challenges are exacerbated in intermittently connected environments such as border checkpoints, aircraft, remote clinics, and IoT gateways where systems must operate locally and later reconcile actions deterministically.

Accordingly, there exists a need for a gateway architecture in which entry is anchored on a user-controlled identity; authorization is enforced at the browser or client runtime as a non-bypassable path; consent is domain-scoped and time-scoped; actions are captured via verifiable receipt objects; and remediation can be executed via bounded rollback under explicit constraints.

### SUMMARY

In various embodiments, a computer-implemented identity gateway is provided for regulated digital interactions over a multi-system honeycomb basepoint network. A client-side browser-resident identity agent intercepts a request for a target domain scope, resolves the request into a versioned compliance profile and routing adjacency constraints, and executes a domain-bound consent state machine that cryptographically binds an authorization output to the target domain scope.

A time-domain mechanism generates or verifies an authorization seal using at least a discrete time bucket and a nonce. For each authorization event or designated high-risk event, the system generates a verifiable receipt object (VRO) including the target domain scope, the discrete time bucket, and a profile version reference, enabling auditability and downstream verification.

Upon detecting an anomaly condition, a bounded rollback or callback remediation procedure is applied subject to boundary rules, including bounds on time window, affected asset scope, propagation depth, and authority conditions. In intermittently connected environments, the system supports local-first verification and deterministic reconciliation upon reconnection.

In some embodiments, the system publishes and governs machine-readable profiles via one or more registries, and maintains a terminology registry, using domain identifiers only as non-limiting examples.

### Technical Effects

The embodiments disclosed herein improve computer and network security and reliability by providing a non-bypassable client-runtime enforcement point and deterministic, machine-verifiable evidence objects.

Non-bypassable enforcement path: by intercepting or gating requests at the browser runtime or controlled client runtime prior to transmission, the system reduces reliance on server-side prompts that may be spoofed or replayed, and reduces bypass via alternate user interface flows.

Domain-bound and time-bound authorization: binding an authorization output to a canonicalized domain scope, a discrete time bucket, and a nonce reduces cross-domain replay and enables bounded revocation windows.

Verifiable receipts for audit and reconciliation: generating a VRO per event supports deterministic downstream verification without requiring replay of sensitive payloads, reducing dispute cost and improving auditability.

Bounded remediation (BEIFR2): constraining rollback by explicit boundary rules limits cascading side effects and improves operational safety in regulated systems.

Local-first operation with deterministic reconciliation: caching verified profiles and keys enables offline or intermittently connected operation while preserving deterministic reconciliation upon reconnection.

### BRIEF DESCRIPTION OF THE DRAWINGS

FIG. 1 illustrates an example system architecture including a browser-resident identity agent, a basepoint resolver, a honeycomb basepoint network, optional registries (standards and terminology), receipt generation and indexing, clearing integration, and bounded rollback.

FIG. 2 illustrates an example verifiable receipt object (VRO) data structure including domain scope binding, time bucket and nonce binding, profile version references, and proof bundles.

FIG. 3 illustrates an example local-first enforcement and deterministic reconciliation flow including online and offline paths, receipt generation, optional IoT command gating and subsequent synchronization, and bounded rollback remediation.

### DETAILED DESCRIPTION OF THE DRAWINGS

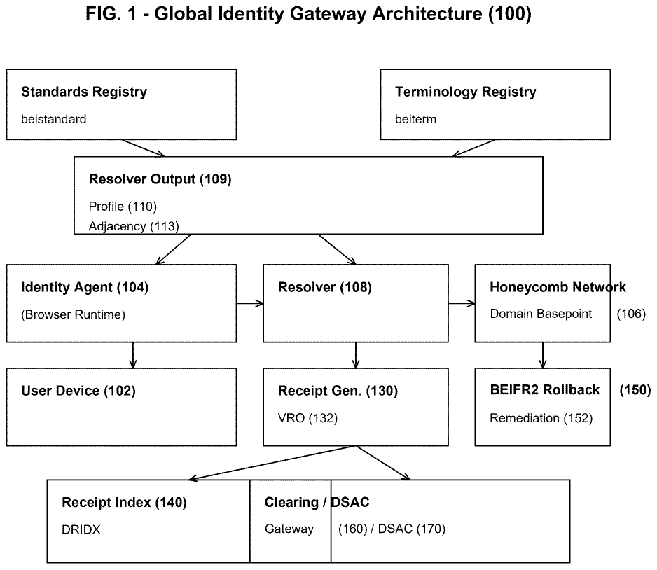

FIG. 1 illustrates an example global identity gateway architecture (system 100). A user device 102 executes or hosts a browser-resident identity agent 104 operating at a browser runtime. The agent 104 interacts with a basepoint resolver 108 to resolve a domain basepoint 106 within a honeycomb basepoint network. The basepoint resolver 108 returns a resolver output 109 including at least a compliance profile identifier and version reference 110 and routing adjacency constraints 113. The agent 104 invokes a receipt generator 130 to generate a verifiable receipt object (VRO) 132 for an authorization event. Receipt references may be indexed via a receipt index 140. An anomaly condition may trigger a BEIFR2 bounded rollback engine 150 to execute remediation 152. A clearing gateway 160 may consume receipt references for settlement or accounting within a domain-scoped asset container (DSAC) 170.

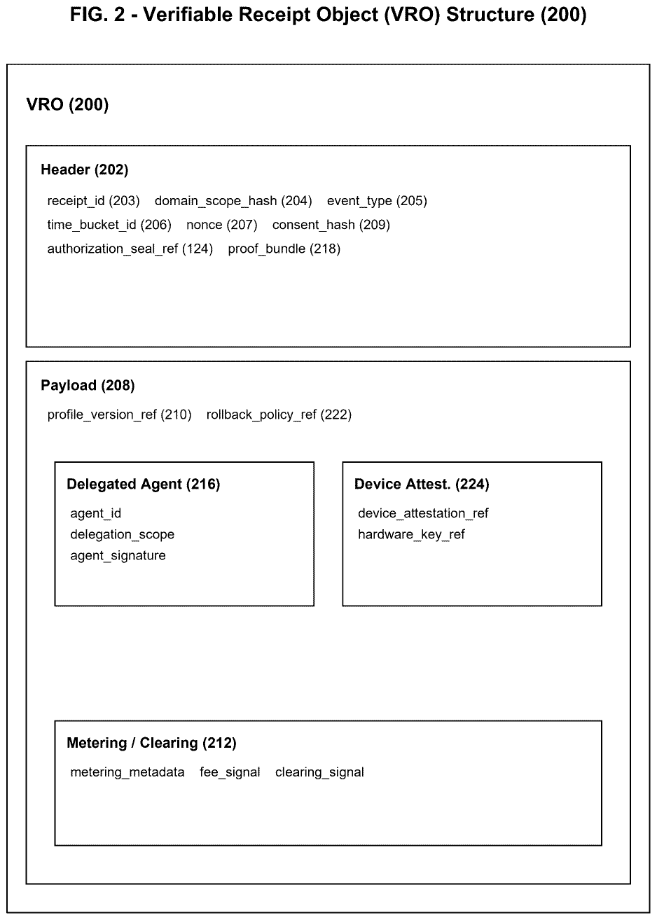

FIG. 2 illustrates an example VRO structure 200. The VRO 200 includes a header 202 and a payload 208. The header 202 may include a receipt_id 203, a domain_scope_hash 204, an event_type 205, a time_bucket_id 206, a nonce 207, and a consent_hash 209, together with an authorization seal reference 124 and a proof_bundle 218 comprising one or more signatures and hashes. The payload 208 may include a profile_version_ref 210 and economic metering or clearing fields 212. In some embodiments, the payload 208 further includes delegated agent fields 216, a rollback_policy_ref 222, and device attestation 224.

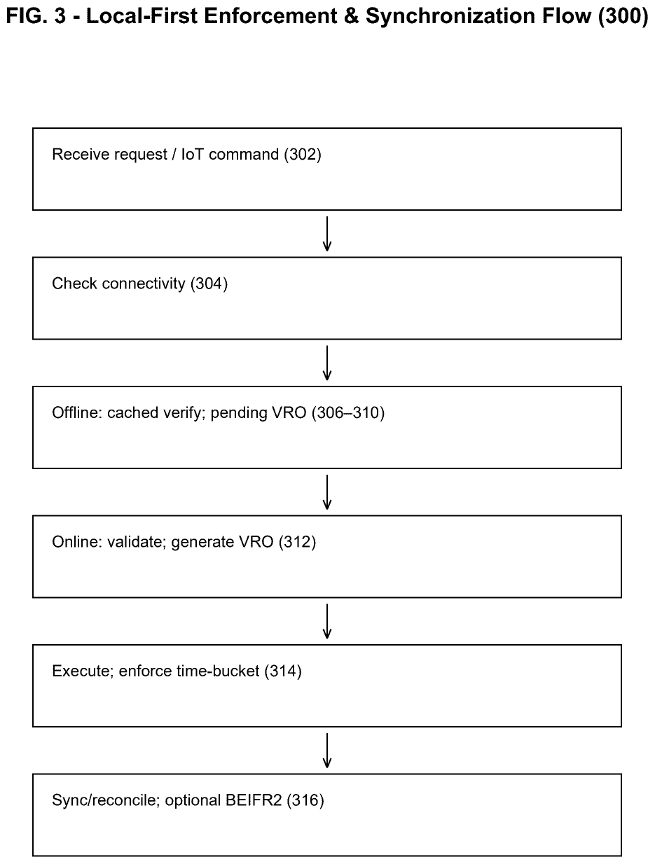

FIG. 3 illustrates an example local-first enforcement and synchronization flow 300. At step 302, a component receives an access request or an Internet of Things (IoT) command. At step 304, network connectivity is evaluated. At steps 306-310, when offline, cached profiles and keys are used for local verification and a pending VRO is generated. At step 312, when online, validation may be performed in real time and a VRO is generated. At step 314, an authorization or command is executed subject to time-bucket constraints. At step 316, receipts are synchronized and reconciled asynchronously, and BEIFR2 remediation may be triggered when boundary rules are satisfied.

### DETAILED DESCRIPTION

### Definitions

Behavioral-Economics Identity (BEI): a user-controlled identity framework in which identity assertions, access permissions, and risk controls may be derived from or associated with behavioral, temporal, and contextual signals, optionally with selective disclosure. “BEI” is used as a technical label for embodiments described herein and does not require any particular economic theory to be implemented unless expressly recited.

BEIDID/EID: a decentralized identifier (DID) and/or an extended identifier (EID) representing a subject under user control, resolvable to a DID document or equivalent record containing verification methods, service endpoints, and policy bindings.

Domain Basepoint/Basepoint: a domain, subdomain, namespace identifier, or equivalent scope identifier representing an entry coordinate (sector, jurisdiction, scenario, resource scope, or service scope). A basepoint may function as a portal, routing node, and policy anchor.

Honeycomb Basepoint Network: a graph of basepoints in which nodes represent basepoints and edges represent authorized adjacency or routing rules.

Browser-Resident Identity Agent: a client-side enforcement component operating at a browser runtime or controlled client runtime, including a browser extension, a browser-integrated module, a controlled webview, or an embedded runtime interceptor.

Domain-Bound Consent: an authorization mechanism in which an authorization output is cryptographically and logically bound to a target domain scope, including by way of example a canonicalized domain hash, a certificate fingerprint binding, and/or a signed basepoint identifier binding.

Time-Domain Bucketing: discretization of time into windows such as hour/day/week/month/year (or other windows) used for token derivation, audit indexing, and revocation windows.

Nonce/Challenge: a one-time or session-unique value used to prevent replay and bind an authorization event to a specific session.

Compliance Profile: a machine-readable policy bundle specifying requirements, including credential types, minimal disclosure constraints, risk thresholds, audit rules, jurisdiction flags, receipt rules, and profile versions. Profiles are versioned and may be rolled back to prior versions.

Verifiable Receipt Object (BEIVRO/VRO)/Receipt Object: a machine-verifiable record of an authorization event or designated high-risk event, including at least domain scope binding, time scope, profile version references, and a cryptographic proof bundle.

BEIFR2 Bounded Rollback: a constrained remediation mechanism that applies rollback or callback actions within explicit boundary rules, including bounds on time window, affected asset scope, propagation depth, and authority conditions.

Domain-Scoped Asset Container (DSAC): a domain-scoped or basepoint-scoped container, ledger namespace, or access-controlled asset scope used to constrain authorization and remediation to a defined set of assets, records, or transactional objects associated with a domain scope and referenced by one or more VROs.

### System Overview

In one embodiment, the gateway comprises: (1) a Basepoint Resolver; (2) a Browser-Resident Identity Agent; (3) a Time-Domain Seal Generator; (4) a Receipt Generator; and (5) a BEIFR2 Bounded Rollback Engine.

Basepoint Resolver. The basepoint resolver receives a target domain scope and returns a resolver output that includes: domain_scope (canonical identifier and/or hash); profile_id and profile_version; required_credentials (credential types and minimum fields); service_endpoints; routing adjacency constraints; and receipt rules indicating events requiring VROs.

Browser-Resident Identity Agent. The agent verifies the target domain scope, obtains a nonce or challenge, performs selective disclosure under the active compliance profile, and produces an authorization output bound to the basepoint scope and a time bucket.

Time-Domain Seal Generator. The seal generator derives an authorization seal using: a discrete time bucket; nonce/challenge; domain scope binding (e.g., domain hash or certificate binding); and one or more verification methods such as a device key or passkey.

Receipt Generator. The receipt generator creates a VRO for authorization events and designated high-risk events including cross-basepoint routing transitions, financial actions, customs/clearance authorizations, healthcare record access, education credential presentation, and device/IoT command gating.

BEIFR2 Bounded Rollback Engine. The rollback engine consumes receipt references, risk triggers, and authority conditions to remediate events within boundary rules.

### Honeycomb Basepoint Network and Routing

The basepoint network may be represented as a graph G=(V, E), where nodes V represent basepoints and edges E represent allowed transitions with constraints. Adjacency constraints may be scoped by: sector (healthcare to insurance to payment to audit), jurisdiction (country/region basepoints), scenario (customs clearance, travel entry, education enrollment), and resource type (credential, record, asset).

The resolver returns adjacency constraints and profile references. The browser-resident identity agent enforces domain-bound consent steps when traversing edges requiring elevated disclosure, higher risk thresholds, or jurisdiction-specific conditions.

### Browser-Native Enforcement

The browser-resident identity agent acts as a first enforcement point by intercepting requests prior to transmission and requiring domain verification before producing any authorization output. Domain verification may incorporate TLS certificate fingerprints, canonicalized domain hashes, signed basepoint identifiers, and trusted registries.

The agent prevents user-interface spoofing by denying authorization outputs unless domain binding checks pass. The agent performs selective disclosure, returning only fields required under the active compliance profile. The agent can store and present VROs to the user and to authorized auditors.

### Domain-Bound Consent State Machine

An example state machine includes: Resolve; Verify Domain/Profile; Challenge/Nonce; Select Disclosure; Derive Seal; Sign/Authorize; Generate Receipt; and Route/Complete (or Deny/Step-Up).

Risk-based transitions may trigger step-up authentication, denial, or receipt escalation. The system may apply denial or downgrade modes when verification fails, including a reduced-permission read-only mode under profile control.

### Data Objects

Basepoint Resolver Output (BRO). Example fields include: domain_scope; profile_id; profile_version; required_credentials; minimum disclosure policy; risk thresholds; receipt rules; adjacency constraints; and endpoints.

Authorization Seal/Identity Seal. Example fields include: subject_id (DID/EID reference); domain_scope_hash and/or certificate binding; time_bucket_id; nonce; optional context_scope_hash; profile references; consent hash; key reference; and signature.

Verifiable Receipt Object (VRO). Example fields include: receipt_id; event_type; domain_scope binding and/or domain_scope_hash; time_bucket_id; profile_id and profile_version; optional attestation references; rollback policy reference; and a proof bundle comprising signatures, hashes, and references.

In privacy-sensitive implementations, the VRO may be split into a header and a protected payload. A header may include indexing fields and proof references, while a payload may include protected fields stored locally and/or under encrypted storage. A receipt reference may be disclosed while access to protected payload content remains controlled by domain-bound consent and, when applicable, BEIFR2 remediation outcomes.

In some embodiments, a VRO further includes delegated agent fields and device attestation fields. Delegated agent fields may include an agent identifier, delegation scope, and an agent signature that is distinct from a subject signature. Device attestation fields may include a device attestation reference and a hardware key reference. In some embodiments, a VRO further includes economic metering and clearing fields, including metering metadata, a fee signal, and a clearing signal that are readable by a downstream clearing gateway while avoiding disclosure of protected payload content.

### Compliance Profiles and Registries

Compliance profiles are machine-readable policy bundles that are versioned, deployable at the resolver and/or the browser agent, and auditable by referencing profile versions in VROs.

Profiles may define credential types, minimum disclosure rules, risk thresholds, receipt rules, and remediation boundary rules.

In some embodiments, profiles and schemas are published via a standards registry portal, and normative definitions are published via a terminology registry. Example (non-limiting) portals may include beistandard.com/beistandard.org/beistandards.com/beistandards.org and beiterm.com. Identity resolution endpoints may be hosted under BEIDID.com and BEIEID.com, and indexing endpoints may be hosted under DRIDX.com, without limiting the invention to any specific domain or naming system.

### Local-First Operation and Deterministic Reconciliation

In intermittently connected environments, the browser-resident identity agent may cache compliance profiles and verification material (e.g., signed profile bundles, key sets, revocation references) and perform local-first verification while disconnected. While offline, the agent may generate pending-sync VROs.

Upon reconnection, the agent performs deterministic reconciliation of pending receipts using canonicalized domain scope bindings, time buckets, nonce uniqueness checks, and receipt hash comparisons. Cache invalidation triggers may include profile version updates, revocation list updates, key rotation events, and authority-mandated policy changes.

### BEIFR2 Bounded Rollback and Callback Remediation

Upon anomaly conditions such as fraud signals, revocation hits, mismatched domain binding, suspicious automation, or policy violations, the BEIFR2 engine:
(a) retrieves relevant VROs by receipt_id or references;
(b) verifies proof bundles and profile versions;
(c) applies boundary rules including: (i) time window bounds, (ii) asset scope bounds limited to receipt-referenced assets or records, (iii) propagation depth bounds limiting downstream side effects, and (iv) authority bounds requiring multi-party threshold approvals, court callback, or regulator callback;
(d) executes remediation actions such as revoking authorizations, freezing access, reversing transfers where permitted, and restoring prior state; and
(e) emits a remediation receipt and audit trail.

Example boundary rule templates (non-limiting) include: financial template (rollback window no more than 24 hours; scope limited to receipt-referenced settlement instruction; propagation depth limited to one hop; authority requires m-of-n signers); healthcare template (rollback window no more than 72 hours; scope limited to record access and disclosure events; authority requires provider plus patient confirmation); and border/IoT template (rollback window no more than 4 hours; scope limited to gate-open authorization; operator approval required; reconciliation performed when connectivity restores).

### Multi-Sector Examples

Customs/Clearance Example. A traveler's basepoint routes to a customs basepoint. The agent enforces domain verification, uses step-up authentication under a customs profile, provides selective disclosure, emits a VRO for clearance authorization, and enables BEIFR2 rollback if identity theft is detected.

Healthcare Example. A user enters a healthcare basepoint. A healthcare profile requires credential proofs and minimum-necessary disclosure. A VRO is generated for record access and medical sign-offs. BEIFR2 rollback can remediate unauthorized access.

Education Example. A user enters an education basepoint. An education profile determines credential checks and disclosure. Routing to a payment basepoint triggers additional consent. VROs unify enrollment, payment, and audit under profile version references.

Finance/Clearing Example. A payment, clearing, or settlement instruction may include a receipt reference identifier and a profile version reference, enabling a downstream clearing gateway to accept or reject the instruction based at least on VRO verification and profile conformance, without requiring disclosure of protected user payload content.

### Security Considerations

Domain-bound authorization mitigates phishing and cross-domain replay. Time-bucket plus nonce reduces repeated reuse of authorization outputs and enables bounded revocation windows. VROs provide auditability and forensic capability. BEIFR2 bounded rollback limits cascading damage under controlled constraints.

Recovery and revocation mechanisms may include device-loss recovery, key rotation, revocation list updates, and profile rollback. Selective disclosure minimizes exposed information. In privacy-sensitive deployments, receipt payloads may be split into a public header and a protected payload stored locally or under encrypted storage.

### Implementation Variations

The browser-resident identity agent may be implemented as an extension, integrated module, or controlled webview. DID/EID methods may use different cryptographic suites. VROs may store full objects, hashes, or references depending on privacy and storage constraints. Compliance profiles can be enforced client-side, server-side, or both. Components may be distributed or combined.

Any domain names, registry names, or namespace identifiers referenced herein are illustrative examples and are not required for practicing the invention. The invention is not limited to any particular domain, naming system, registry, or top-level domain structure.

### REFERENCE NUMERALS

100 system/global identity gateway architecture
102 user device
104 browser-resident identity agent
106 domain basepoint/basepoint network node
108 basepoint resolver
109 resolver output (BRO)
110 compliance profile identifier/version reference
113 routing adjacency constraints
124 authorization seal reference
130 receipt generator
132 verifiable receipt object (VRO)
140 receipt index
150 BEIFR2 bounded rollback engine
152 remediation
160 clearing gateway
170 domain-scoped asset container (DSAC)
200 verifiable receipt object (VRO) structure
202 VRO header
203 receipt_id
204 domain_scope_hash
205 event_type
206 time_bucket_id
207 nonce
208 VRO payload
209 consent_hash
210 profile_version_ref
212 economic metering/fee/clearing fields
216 delegated agent fields
218 proof_bundle
222 rollback_policy_ref
224 device attestation
300 local-first enforcement and synchronization flow
302 receive request/IoT command
304 check connectivity
306 offline path: cached verification
310 pending VRO generation
312 online validation path
314 execute authorization/command; enforce time-bucket constraints
316 asynchronous synchronize/reconcile; optional BEIFR2 trigger

1. A global identity gateway system, comprising: one or more processors; and one or more non-transitory memories storing instructions that, when executed, cause the system to: receive a target domain scope identifying a domain basepoint within a multi-system honeycomb basepoint network; resolve, by a basepoint resolver, the target domain scope into a resolver output comprising at least (i) a machine-readable compliance profile identifier and a profile version, and (ii) routing adjacency constraints; enforce, by a browser-resident identity agent operating at a client runtime, a domain-bound consent state machine that cryptographically binds an authorization output to the target domain scope; generate or verify, by a time-domain component, an authorization seal derived from at least a discrete time bucket and a nonce; generate, by a receipt generator, a verifiable receipt object for at least one authorization event, the verifiable receipt object including at least the target domain scope, the discrete time bucket, and a profile version reference; and upon detecting an anomaly condition, apply, by a bounded rollback engine, a bounded rollback or callback remediation procedure subject to one or more boundary rules.

2. A global identity gateway method, comprising: receiving a target domain scope identifying a domain basepoint; resolving the target domain scope into a resolver output comprising at least a compliance profile identifier, a profile version, and routing adjacency constraints; executing, at a client runtime by a browser-resident identity agent, a domain-bound consent state machine that binds an authorization output to the target domain scope; generating or verifying an authorization seal using at least a discrete time bucket and a nonce; generating a verifiable receipt object including the target domain scope, the discrete time bucket, and the profile version reference; and upon detecting an anomaly condition, applying a bounded rollback or callback remediation constrained by one or more boundary rules.

3. A non-transitory computer-readable medium storing instructions that, when executed by one or more processors, cause performance of operations comprising: receiving a target domain scope identifying a domain basepoint; resolving the target domain scope into a resolver output comprising at least a compliance profile identifier, a profile version, and routing adjacency constraints; enforcing, at a client runtime, a domain-bound consent state machine that cryptographically binds an authorization output to the target domain scope; generating or verifying an authorization seal derived from at least a discrete time bucket and a nonce; generating a verifiable receipt object including at least the target domain scope, the discrete time bucket, and the profile version reference; and upon detecting an anomaly condition, applying a bounded rollback or callback remediation subject to one or more boundary rules.

4. The system of claim 1, wherein the honeycomb basepoint network is represented as a graph data structure comprising basepoint nodes and adjacency edges, and wherein the routing adjacency constraints define allowed transitions between the basepoint nodes.

5. The system of claim 1, wherein the browser-resident identity agent comprises at least one of a browser extension, a browser-integrated module, or a controlled webview component configured to intercept a resource request prior to network transmission.

6. The system of claim 1, wherein binding the authorization output to the target domain scope comprises binding to at least one of a canonicalized domain hash, a certificate fingerprint, or a signed basepoint identifier.

7. The system of claim 1, wherein the discrete time bucket comprises at least one of an hour bucket, a day bucket, a week bucket, a month bucket, or a year bucket.

8. The system of claim 1, wherein the authorization seal further incorporates a context scope hash corresponding to a scenario type defined by the compliance profile.

9. The system of claim 1, wherein the verifiable receipt object further comprises at least one of an event type, a consent hash, an attestation reference, a risk score reference, a rollback policy reference, or a proof bundle comprising one or more signatures and hashes.

10. The system of claim 1, wherein the compliance profile is versioned and supports rollback to a prior version, and wherein the verifiable receipt object records the profile version reference for auditability.

11. The method of claim 2, wherein enforcing the domain-bound consent state machine comprises verifying the target domain scope against a trusted registry prior to producing the authorization output, and denying access or downgrading access upon verification failure.

12. The method of claim 2, wherein generating or verifying the authorization seal comprises generating a one-time authorization token that becomes invalid outside a predefined validity window associated with the discrete time bucket.

13. The method of claim 2, wherein generating the verifiable receipt object is enforced for at least one of cross-basepoint routing, digital signing, payment authorization, clearing authorization, settlement authorization, minting or issuance authorization, or sensitive data disclosure.

14. The system of claim 1, wherein the anomaly condition comprises at least one of a risk score exceeding a threshold, a credential revocation match, a domain-scope mismatch, or detection of suspicious automation behavior.

15. The system of claim 1, wherein the boundary rules comprise at least one of a rollback time window limit, an affected asset scope limit, a downstream propagation depth limit, or an authority threshold condition.

16. The system of claim 1, further comprising a selective disclosure component configured to disclose, under the compliance profile, a subset of credential fields satisfying a minimum-necessary rule, and to record a disclosure policy reference in the verifiable receipt object.

17. The system of claim 1, wherein the verifiable receipt object further comprises a metering metadata field or a fee signal configured to be readable by a downstream clearing system for settlement, taxation, or service-fee accounting without exposing protected user payload content.

18. The system of claim 1, wherein the browser-resident identity agent is configured for local-first verification by using cached compliance profiles and cached verification material while disconnected from a network, and is further configured to perform deterministic reconciliation and asynchronous synchronization when network connectivity is restored.

19. The system of claim 1, further comprising an IoT enforcement component configured to gate at least one device command or device data access using the authorization output and a receipt reference, wherein the device command or device data access is restricted by the target domain scope and the discrete time bucket.

20. The system of claim 1, wherein the bounded rollback or callback remediation procedure is a BEI-associated bounded rollback mechanism referred to as BEIFR2 and configured to emit a remediation receipt and audit trail upon applying the boundary rules.
